(19) United States
(12) Patent Application Publication
(10) Pub. No.: US 2023/0341634 A1
(43) Pub. Date: Oct. 26, 2023

(54) FERRULE, OPTICAL CONNECTOR, AND METHOD FOR MANUFACTURING OPTICAL CONNECTOR

(71) Applicants: SUMITOMO ELECTRIC INDUSTRIES, LTD., Osaka-shi, Osaka (JP); NIPPON TSUSHIN DENZAI CO., LTD., Komaki-shi, Aichi (JP)

(72) Inventors: Yuto FUJIHARA, Osaka-shi (JP); Sho YAKABE, Osaka-shi (JP); Dai SASAKI, Osaka-shi (JP); Motoyoshi KIMURA, Komaki-shi (JP); Manabu IZAKI, Komaki-shi (JP)

(73) Assignees: SUMITOMO ELECTRIC INDUSTRIES, LTD., Osaka-shi, Osaka (JP); NIPPON TSUSHIN DENZAI CO., LTD., Komaki-shi, Aichi (JP)

(21) Appl. No.: 18/022,423

(22) PCT Filed: Sep. 3, 2021
(86) PCT No.: PCT/JP2021/032492

§ 371 Date: Feb. 21, 2023

(30) Foreign Application Priority Data
Sep. 25, 2020 (JP) 2020-161252

(51) Int. Cl. G02B 6/38

(52) U.S. Cl. CPC G02B 6/3861; G02B 6/3885; G02B 6/3849; G02B 6/3839; G02B 6/3825

(57) ABSTRACT

A ferrule includes a first end surface and a second end surface, an outer surface, an accommodating part, a plurality of guide grooves, a window part, and a pressing part. The plurality of guide grooves are provided to each extend in the first direction on an inner wall of the accommodating part and be aligned in a second direction intersecting the first direction. The window part opens at the outer surface and is connected to the accommodating part. The pressing part is disposed in the window part to press the plurality of optical fibers toward the plurality of guide grooves. The window part is provided at a position facing at least a portion of the plurality of guide grooves. The pressing part can be fitted into the window part so that a gap is provided between an inner wall of the window part and the pressing part.

### TECHNICAL FIELD

The present disclosure relates to a ferrule, an optical connector, and a method for manufacturing an optical connector. The present application claims priority based on Japanese Patent Application No. 2020-161252 filed on Sep. 25, 2020, the entire contents of which are incorporated herein by reference.

### BACKGROUND ART

Patent Literature 1 discloses an example of a ferrule that collectively holds a plurality of optical fibers. The ferrule has an opening on one end surface, and a plurality of optical fibers are accommodated inside the ferrule through the opening. There are cases in which a plurality of guide grooves extending in a direction of accommodating the optical fibers are formed on an inner wall of such a ferrule. In this case, the optical fibers are accommodated inside the ferrule along the guide grooves. Also, an adhesive is injected into the inside of the ferrule to fix the optical fibers to the inner wall of the ferrule. Patent Literature 2 discloses another example of the ferrule.

### CITATION LIST

### Patent Literature

[Patent Literature 1] PCT International Publication No. WO 2018/116855
[Patent Literature 2] Japanese Unexamined Patent Publication No. 2018-101024
[Patent Literature 3] PCT International Publication No. WO 2015/152282
[Patent Literature 4] PCT International Publication No. WO 2017/086388

### SUMMARY OF INVENTION

The present disclosure provides, as one aspect, a ferrule. The ferrule includes a first end surface and a second end surface, an outer surface, an accommodating part, a plurality of guide grooves, a window part, and a pressing part. The first end surface and the second end surface are provided opposite to each other in a first direction. The outer surface is provided between the first end surface and the second end surface. The accommodating part opens at the second end surface and is able to accommodate a plurality of optical fibers therein. The plurality of guide grooves are configured to determine a position and a direction of each of the plurality of optical fibers in the accommodating part. The plurality of guide grooves are provided to each extend in the first direction on an inner wall of the accommodating part and be aligned in a second direction intersecting the first direction. The window part opens at the outer surface and is connected to the accommodating part. The pressing part is disposed in the window part to press the plurality of optical fibers toward the plurality of guide grooves. The window part is provided at a position facing at least a portion of the plurality of guide grooves. The pressing part can be fitted into the window part so that a gap is provided between an inner wall of the window part and the pressing part.

The present disclosure provides, as another aspect, an optical connector. The optical connector includes the above-described ferrule, a plurality of optical fibers, and an adhesive. The plurality of optical fibers are accommodated in an accommodating part of the ferrule along a plurality of guide grooves. The adhesive is injected into the accommodating part through a window part to fix the plurality of optical fibers to the inner wall of the accommodating part.

The present disclosure provides, as yet another aspect, a method for manufacturing an optical connector. The method for manufacturing an optical connector includes accommodating a plurality of optical fibers in the accommodating part of the ferrule along the plurality of guide grooves, injecting an adhesive for fixing the plurality of optical fibers to the inner wall of the accommodating part into the accommodating part through the window part, and fitting the pressing part into the window part to press the plurality of optical fibers toward the plurality of guide grooves.

### BRIEF DESCRIPTION OF DRAWINGS

FIG. 1 is a perspective view illustrating an optical connector according to one embodiment.

FIG. 2 is a perspective view illustrating a state in which a pressing part is fitted into a window part of the optical connector illustrated in FIG. 1.

FIG. 3 is a cross-sectional view schematically illustrating a cross section of the optical connector illustrated in FIG. 2 taken along line III-III.

FIG. 4 is a cross-sectional view schematically illustrating a cross section of the optical connector illustrated in FIG. 2 taken along line IV-IV.

FIG. 5 is a view of the optical connector with the pressing part fitted into the window part seen from an upper surface side.

FIG. 6 is a view schematically illustrating a cross section of the optical connector with an adhesive injected into an accommodating part.

FIG. 7 is a flowchart showing a method for manufacturing an optical connector.

FIG. 8 is a perspective view illustrating an optical connector according to a first modified example.

FIG. 9 is a perspective view illustrating an optical connector according to a second modified example.

FIG. 10 is a perspective view illustrating an optical connector according to a third modified example.

FIG. 11 is a perspective view illustrating an optical connector according to a fourth modified example.

FIG. 12 is a perspective view illustrating an optical connector according to a fifth modified example.

FIG. 13 is a perspective view illustrating an optical connector according to a sixth modified example.

### DESCRIPTION OF EMBODIMENTS

### Object to be Solved by the Present Disclosure

In the conventional ferrule described above, dust or part of coating of the optical fiber may be caught between the guide groove and the optical fiber, and this may cause the optical fiber to be floated upward. The optical fiber is fixed to an inner wall of the ferrule by an adhesive injected into the ferrule and thereby the floating is suppressed to some extent, but further improvement is desired. Also, when the adhesive is injected into the inside of the ferrule, bubbles may be mixed into the adhesive. If such bubbles are positioned on an optical path of the optical fiber, there is a likelihood that Fresnel loss and deviation of the optical path will occur. Therefore, a technology capable of preventing the optical fiber from floating upward and curbing mixing of bubbles into adhesive is desired.

An objective of the present disclosure is to provide a ferrule, an optical connector, and a method for manufacturing an optical connector capable of preventing an optical fiber from floating upward and curbing mixing of bubbles into an adhesive injected into the inside of the ferrule.

### Effects of the Present Disclosure

According to the present disclosure, as one aspect, an optical fiber can be prevented from floating upward, and mixing of bubbles into an adhesive injected into the inside of the ferrule can be curbed.

### DESCRIPTION OF EMBODIMENTS OF THE PRESENT DISCLOSURE

First, contents of an embodiment of the present disclosure will be listed and described. A ferrule according to one embodiment includes a first end surface and a second end surface, an outer surface, an accommodating part, a plurality of guide grooves, a window part, and a pressing part. The first end surface and the second end surface are provided opposite to each other in a first direction. The outer surface is provided between the first end surface and the second end surface. The accommodating part opens at the second end surface and is able to accommodate a plurality of optical fibers therein. The plurality of guide grooves are configured to determine a position and a direction of each of the plurality of optical fibers in the accommodating part. The plurality of guide grooves are provided to each extend in the first direction on an inner wall of the accommodating part and be aligned in a second direction intersecting the first direction. The window part opens at the outer surface and is connected to the accommodating part. The pressing part is disposed in the window part to press the plurality of optical fibers toward the plurality of guide grooves. The window part is provided at a position facing at least a portion of the plurality of guide grooves. The pressing part can be fitted into the window part so that a gap is provided between an inner wall of the window part and the pressing part.

In this ferrule, the pressing part is fitted into the window part provided at a position facing the guide grooves, and the plurality of optical fibers are pressed toward the guide grooves by the pressing part. Thereby, the optical fibers can be prevented from floating upward from the guide grooves. Also, the pressing part can be fitted so that a gap is provided between the inner wall of the window part and the pressing part. Thereby, even if bubbles are generated in the adhesive that has been injected into the accommodating part of the ferrule, the bubbles can be removed through the gap, and mixing of the bubbles into the adhesive can be curbed. Further, since a coating resin of the optical fiber or the adhesive is prevented from being caught between the pressing part and the inner wall of the window part by the provision of the gap, damage to the optical fiber or the like can be prevented.

As one embodiment of the ferrule, the pressing part may be fitted into the window part so that a first gap positioned on the first end surface side with respect to the pressing part is provided between the inner wall of the window part and the pressing part. According to this aspect, of the outer surface of the ferrule, the first gap is provided on the first end surface side in which a distal end of the optical fiber is accommodated. Thereby, even if bubbles are generated in the adhesive positioned in the vicinity of the distal end of the optical fiber, the bubbles can be removed through the first gap. Therefore, Fresnel loss and deviation of an optical axis due to, for example, bubbles generated on the optical axis of the optical fiber can be more reliably prevented.

As one embodiment of the ferrule, the pressing part may be fitted into the window part so that a second gap positioned on the second end surface side with respect to the pressing part is provided between the inner wall of the window part and the pressing part. According to this aspect, bubbles generated in the adhesive can be more efficiently removed not only through the first gap but also through the second gap.

As one embodiment of the ferrule, the pressing part may be fitted into the window part so that the gaps extend in the second direction. According to this aspect, the pressing part is fitted so that the gaps are provided in a direction (second direction) in which the plurality of optical fibers are aligned. Thereby, bubbles generated around each of the optical fibers can be more reliably removed through the gaps.

As one embodiment of the ferrule, the pressing part may be a plate-shaped member having a flat pressing surface which presses the plurality of optical fibers toward the plurality of guide grooves. In this case, the pressing surface may have a surface roughness of 1 μm or less. According to this aspect, since the plurality of optical fibers are pressed by the flat pressing surface, a load being concentrated on a specific optical fiber can be suppressed. Thereby, damage to the optical fibers can be prevented.

As one embodiment of the ferrule, a step having a placement surface on which an end portion of the pressing part is able to be placed may be formed on the inner wall of the window part. According to this aspect, since movement of the pressing part toward the guide grooves is restricted by the placement surface of the step, the pressing part is not excessively pushed toward the guide grooves. Thereby, damage to the optical fibers positioned between the pressing part and the guide grooves can be prevented.

As one embodiment of the ferrule, a depth from the outer surface to the placement surface may be larger than a thickness of the pressing part. According to this aspect, the entire structure of the pressing part is accommodated in the window part and does not protrude from an opening of the window part toward the outside of the ferrule. Thereby, miniaturization of the optical connector can be achieved. Also, when the ferrule is inserted into an adapter or a housing, it is possible to prevent the pressing part from being caught by an inner surface thereof and coming off.

As one embodiment of the ferrule, the window part may include a first portion whose opening width on the outer surface in the second direction is larger than a width of the pressing part in the second direction, and a second portion and a third portion whose opening widths on the outer surface in the second direction are each smaller than the width of the pressing part in the second direction. The second portion and the third portion may be positioned to sandwich the first portion in the first direction. The pressing part may be fitted into the first portion. Thereby, fitting of the pressing part into an appropriate position of the window part is facilitated. Also, a positional deviation of the pressing part in the first direction is prevented.

As one embodiment of the ferrule, a sloped surface may be formed in at least one of the inner wall of the window part and a surface of the pressing part which define the gap so that an opening area of the gap on the outer surface side is larger than an opening area of the gap on the accommodating part side. According to this aspect, when an amount of the adhesive injected into the accommodating part is too much, it can be noticed quickly, and the adhesive can be prevented from overflowing from the gap to the outside of the ferrule.

An optical connector according to one embodiment includes any one of the ferrules described above, a plurality of optical fibers, and an adhesive. The plurality of optical fibers are accommodated in the accommodating part of the ferrule along the plurality of guide grooves. The adhesive is injected into the accommodating part through the window part to fix the plurality of optical fibers to the inner wall of the accommodating part.

In this optical connector, the optical fibers are fixed to the inner wall of the accommodating part by the adhesive, and the optical fibers are pressed toward the guide grooves by the pressing part. Thereby, the optical fibers are prevented from floating upward. Further, even if bubbles are generated inside the adhesive, the bubbles can be removed through the gap between the inner wall of the window part and the pressing part, and mixing of the bubbles into the adhesive can be curbed.

A method for manufacturing an optical connector according to one embodiment is a method for manufacturing an optical connector having any one of the ferrules described above, and includes accommodating a plurality of optical fibers in the accommodating part of the ferrule along the plurality of guide grooves, injecting an adhesive for fixing the plurality of optical fibers to the inner wall of the accommodating part into the accommodating part through the window part, and fitting the pressing part into the window part to press the plurality of optical fibers toward the plurality of guide grooves.

In this method for manufacturing an optical connector, the optical fibers are fixed to the inner wall of the accommodating part by injecting the adhesive into the accommodating part. Also, the optical fibers are pressed toward the guide grooves by fitting the pressing part into the window part. Thereby, the optical fibers are prevented from floating upward. Also, even if bubbles are generated in the adhesive injected into the accommodating part, the bubbles can be removed through the gap between the inner wall of the window part and the pressing part, and mixing of the bubbles into the adhesive can be curbed.

### DETAILED DESCRIPTION OF EMBODIMENTS OF THE PRESENT DISCLOSURE

Specific examples of a ferrule, an optical connector, and a method for manufacturing an optical connector according to one embodiment of the present disclosure will be described below with reference to the drawings. The present disclosure is not limited to these examples but is indicated by the scope of the claims, and is intended to include meanings equivalent to the claims and all modifications within the scope. In the description of the drawings, the same elements will be denoted by the same reference signs, and duplicate description thereof will be omitted.

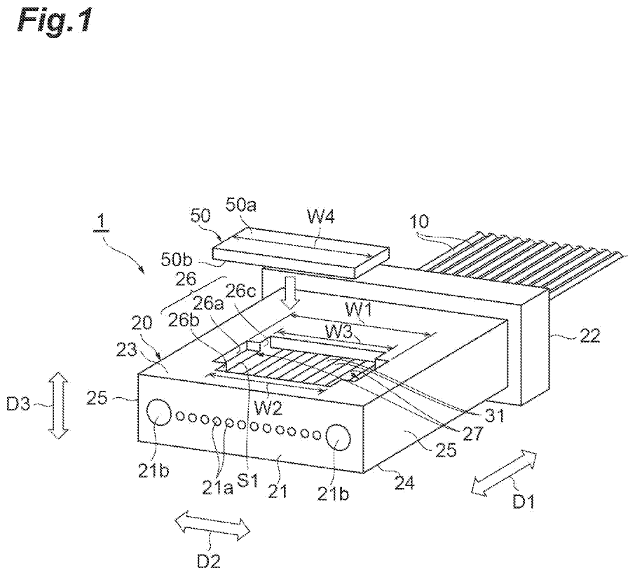

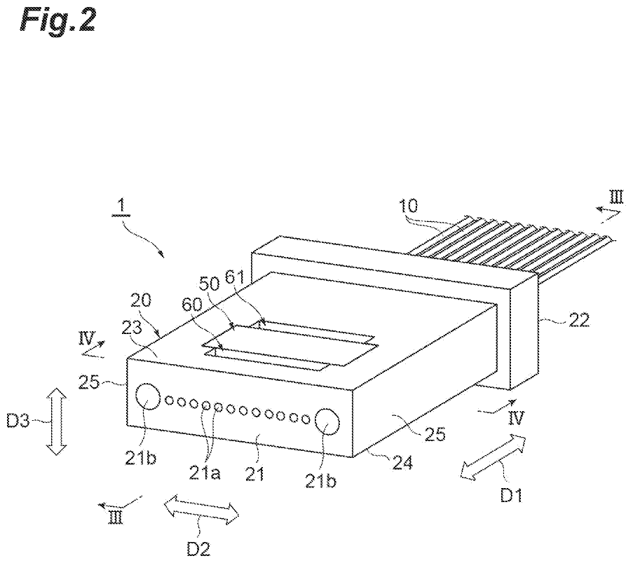

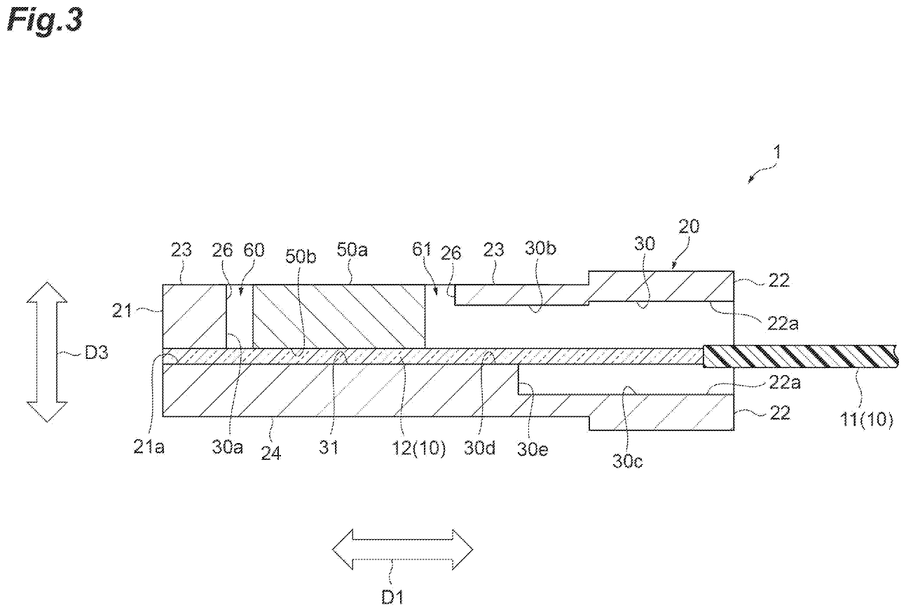

A configuration of an optical connector 1 according to one embodiment will be described using FIGS. 1 to 3. FIG. 1 is a perspective view illustrating the optical connector 1 according to one embodiment. Further, for convenience of explanation, illustration of a portion (a portion positioned inside a guide groove 31) of an optical fiber 10 inserted into a ferrule 20 is omitted in FIG. 1. FIG. 2 is a perspective view illustrating a state in which a pressing part 50 is fitted into a window part 26 of the optical connector 1 illustrated in FIG. 1. FIG. 3 is a cross-sectional view schematically illustrating a cross section of the optical connector 1 illustrated in FIG. 2 taken along line III-III. Hereinafter, for the sake of explanation, a longitudinal direction of the ferrule 20 is referred to as a direction D1 (first direction), a transverse direction of the ferrule 20 is referred to as a direction D2 (second direction), and a thickness direction of the ferrule 20 is referred to as a direction D3.

The optical connector 1 includes a plurality of optical fibers 10 and the ferrule 20. Each of the optical fibers 10 is a member for transmitting an optical signal. The optical fibers 10 are provided to extend in the direction D1 and be aligned in the direction D2 intersecting the direction D1 (perpendicularly in the present embodiment). In the present embodiment, the number of optical fibers 10 is, for example, twelve in total, but the number of optical fibers 10 is not limited thereto, and may be, for example, four, eight, twenty-four, or the like. As illustrated in FIG. 3, each of the optical fibers 10 includes a coated portion 11 and a coating-removed portion 12 positioned on a distal end side of the optical fiber 10 with respect to the coated portion 11. The coated portion 11 is a portion in which a coating resin is coated around a clad. An outer diameter of the coated portion 11 may be, for example, 50 μm or more and 500 μm or less. The coating-removed portion 12 is a portion from which the coating resin around the clad has been removed. An outer diameter of the coating-removed portion 12 may be, for example, 30 μm or more and 300 μm or less. The plurality of optical fibers 10 are accommodated in an internal space (accommodating part 30) of the ferrule 20 through an opening 22a provided at a second end surface 22 of the ferrule 20. In the present embodiment, as an example, the entire coating-removed portion 12 and an end portion of the coated portion 11 are accommodated in the accommodating part 30.

The ferrule 20 is a part that holds end portions of the plurality of optical fibers 10, and may be, for example, an MT ferrule. The ferrule 20 has an appearance in a substantially rectangular parallelepiped shape. The ferrule 20 may be formed of a resin such as, for example, polyphenylene sulfide (PPS). The ferrule 20 includes a first end surface 21, the second end surface 22, an upper surface (outer surface) 23, a lower surface 24, a pair of side surfaces 25, the accommodating part 30, a plurality of guide grooves 31, and the pressing part 50.

As illustrated in FIG. 1, the first end surface 21 is an end surface provided at a distal end of the ferrule 20 and extends in the direction D2 and the direction D3. The first end surface 21 is opposite to the second end surface 22 in the direction D1. The first end surface 21 has a plurality of through holes 21a and a pair of guide holes 21b. Each of the through holes 21a is a hole formed in the direction D1 from the first end surface 21 toward the second end surface 22. The through holes 21a are aligned in the direction D2. The number of the through holes 21a is the same as or larger than the number of the plurality of the optical fibers 10 accommodated in the ferrule 20. As illustrated in FIG. 3, each through hole 21a is positioned between the first end surface 21 and a distal end side inner surface 30a of the accommodating part 30 in the direction D1. One end of each through hole 21a is exposed to the outside of the ferrule 20 at the first end surface 21. On the other hand, the other end of each through hole 21a is connected to the accommodating part 30 at the distal end side inner surface 30a. Each through hole 21a is configured to have an inner diameter larger than an outer diameter of the coating-removed portion 12 of each optical fiber 10. Thereby, distal end portions of the plurality of coating-removed portions 12 can be inserted into the inside of the plurality of through holes 21a.

Further, the ferrule 20 may not necessarily have to have the through holes 21a. In this case, a distal end surface of the optical fiber 10 accommodated in the accommodating part 30 comes into contact with the distal end side inner surface 30a of the accommodating part 30. Also, the ferrule 20 is formed of a light-transmitting resin, and light emitted from each optical fiber 10 can transmit between the distal end side inner surface 30a and the first end surface 21. Also, the first end surface 21 may have a plurality of lenses at positions overlapping optical axes of the plurality of optical fibers 10. In this case, light emitted from each optical fiber 10 is collimated by each lens and then is incident on an optical fiber on the opposite side.

The pair of guide holes 21b are holes formed from the first end surface 21 toward the second end surface 22. As illustrated in FIG. 2, the pair of guide holes 21b are provided at both ends of the first end surface 21 in the direction D2. The guide holes 21b may be through holes penetrating from the first end surface 21 to the second end surface 22, or may be non-through holes having bottom surfaces. One end of a guide pin (not illustrated) having, for example, a columnar outer shape is inserted into each of the guide holes 21b. The other end of the guide pin is inserted into a guide hole similarly formed in a ferrule on the opposite side. Positioning of the ferrules using the guide pins can be performed by the guide holes.

The second end surface 22 is a surface opposite to the first end surface 21 in the direction D1 and extends in the direction D2 and the direction D3. As illustrated in FIG. 3, the second end surface 22 has an opening 22a. The opening 22a is connected to the accommodating part 30, and end portions of the optical fibers 10 are accommodated in the accommodating part 30 through the opening 22a.

The upper surface (outer surface) 23 is a surface provided between the first end surface 21 and the second end surface 22 and extends in the direction D1 and the direction D2. The upper surface 23 is opposite to the lower surface 24 in the direction D3. Hereinafter, a side in which the upper surface 23 is positioned in the direction D3 is referred to as an upper side of the ferrule 20, and a side in which the lower surface 24 is positioned is referred to as a lower side of the ferrule 20.

A window part 26 is provided on the upper surface 23. As illustrated in FIG. 2, the pressing part 50 to be described later is fitted into the window part 26. Also, as illustrated in FIG. 3, the window part 26 opens at the upper surface 23 and an upper inner surface 30b of the accommodating part 30. That is, the window part 26 opens in the upper side and the lower side in the direction D3. The window part 26 is provided at a position facing the plurality of guide grooves 31 provided on a fiber support surface 30d of the accommodating part 30. Thereby, the optical fibers 10 accommodated in the accommodating part 30 are pressed toward the guide grooves 31 by the pressing part 50 fitted into the window part 26. Also, since the window part 26 is provided at a position facing the plurality of guide grooves 31, the plurality of guide grooves 31 are visually noticeable through the window part 26 as illustrated in FIG. 1.

As illustrated in FIG. 1, the window part 26 includes a first portion 26a, a second portion 26b, and a third portion 26c having different opening widths in the direction D2. The first portion 26a is positioned to be sandwiched between the second portion 26b and the third portion 26c in the direction D1. An end portion of the first portion 26a on the first end surface 21 side is connected to an end portion of the second portion 26b on the second end surface 22 side. Also, an end portion of the first portion 26a on the second end surface 22 side is connected to an end portion of the third portion 26c on the first end surface 21 side. That is, the first portion 26a, the second portion 26b, and the third portion 26c are spatially connected to each other to form one window part 26.

The first portion 26a has an opening width W1 in the direction D2 on the upper surface 23. Similarly, the second portion 26b and the third portion 26c have an opening width W2 and an opening width W3 in the direction D2 on the upper surface 23. The opening width W1 of the first portion 26a is larger than the opening width W2 of the second portion 26b and the opening width W3 of the third portion 26c. That is, the opening of the first portion 26a is formed to protrude outward in the direction D2 of the ferrule 20 with respect to the openings of the second portion 26b and the third portion 26c. Also, the first portion 26a has steps 27. The step 27 is provided on each of inner walls of the first portions 26a facing each other in the direction D2. Since the steps 27 are provided, a width of the first portion 26a (a distance between the facing inner walls) in the direction D2 is larger at an upper portion of the steps 27 than at a lower portion of the steps 27. The step 27 has a placement surface S1. The placement surface S1 is a flat surface extending in the direction D1 and the direction D2, and an end portion of the pressing part 50 fitted in the window part 26 is placed thereon. A width of the placement surface S1 in the direction D2 may be, for example, 0.1 mm or more and 1 mm or less.

The second portion 26b is positioned on the first end surface 21 side with respect to the first portion 26a and is provided to extend in the direction D2. As described above, the second portion 26b has the opening width W2 in the direction D2 on the upper surface 23. The opening width W2 of the second portion 26b is smaller than the opening width W1 of the first portion 26a. The opening width W2 of the second portion 26b is equal to the opening width W3 of the third portion 26c in size. The third portion 26c is positioned on the second end surface 22 side with respect to the first portion 26a and is provided to extend in the direction D2. As described above, the third portion 26c has the opening width W3 in the direction D2 on the upper surface 23. The opening width W1 of the first portion 26a, the opening width W2 of the second portion 26b, and the opening width W3 of the third portion 26c may be, for example, 1 mm or more and 10 mm or less in size.

Further, the opening width W1 of the first portion 26a may not necessarily be larger than the opening width W2 of the second portion 26b and the opening width W3 of the third portion 26c. For example, the opening width W1 may be equal to or smaller than the opening width W2 or the opening width W3 in size. Also, the opening width W2 may be different from the opening width W3 in size.

The lower surface 24 is a surface provided between the first end surface 21 and the second end surface 22, and extends in the direction D1 and the direction D2. The lower surface 24 is opposite to the upper surface 23 in the direction D3. The pair of side surfaces 25 are surfaces provided between the first end surface 21 and the second end surface 22, and extend in the direction D1 and the direction D3. The pair of side surfaces 25 are opposite to each other in the direction D2.

The accommodating part 30 is an internal space of the ferrule 20 and can accommodate end portions of the plurality of optical fibers 10. As illustrated in FIG. 3, the inner wall defining the accommodating part 30 has the distal end side inner surface 30a, the upper inner surface 30b, a lower inner surface 30c, and the fiber support surface 30d.

The distal end side inner surface 30a is a surface positioned on a rear side of the first end surface 21 and extends in the direction D2 and the direction D3. The distal end side inner surface 30a has openings of the plurality of through holes 21a. The upper inner surface 30b is a surface positioned on a rear side of the upper surface 23 and extends in the direction D1 and the direction D2. The upper inner surface 30b has the opening of the window part 26. The lower inner surface 30c and the fiber support surface 30d are surfaces positioned on a rear side of the lower surface 24 and extend in the direction D1 and the direction D2. Also, the lower inner surface 30c and the fiber support surface 30d face the upper inner surface 30b in the direction D3. The lower inner surface 30c is positioned on the second end surface 22 side with respect to the fiber support surface 30d. An end portion of the lower inner surface 30c on the first end surface 21 side is connected to an end portion of the fiber support surface 30d on the second end surface 22 side by a step 30e. Thereby, the lower inner surface 30c is positioned on a lower side with respect to the fiber support surface 30d. A separation distance from the upper inner surface 30b to the lower inner surface 30c is larger than a separation distance from the upper inner surface 30b to the fiber support surface 30d. Therefore, since the opening 22a can be formed to be large, the optical fibers 10 can be easily accommodated in the accommodating part 30 through the opening 22a. Also, since the separation distance between the upper inner surface 30b and the fiber support surface 30d is small on the first end surface 21 side, movement of the optical fibers 10 in the direction D3 is restricted, and positioning of the optical fibers 10 can be facilitated.

The fiber support surface 30d has the plurality of guide grooves 31 on which the plurality of optical fibers 10 are disposed. The plurality of guide grooves 31 are configured to determine positions and directions of the plurality of optical fibers 10 in the accommodating part 30. The plurality of guide grooves 31 are provided at a position facing the window part 26. Thereby, as illustrated in FIG. 1, at least a portion of the plurality of guide grooves 31 are visually noticeable through the window part 26. The guide grooves 31 are grooves extending in the direction D1 and are provided to be aligned in the direction D2. The guide grooves 31 are formed in the same number as the number of the through holes 21a, and in the present embodiment, 12 guide grooves 31 are formed. As illustrated in FIG. 3, an end portion of the guide groove 31 on the first end surface 21 side is connected to the through hole 21a. Also, an end portion of the guide groove 31 on the second end surface 22 side opens at a surface of the step 30e. The distal end of the optical fiber 10 is accommodated in the guide groove 31 through the opening provided at the step 30e, and moves to the first end surface 21 side along the guide groove 31 to be inserted into the through hole 21a. The guide groove 31 may be formed such that a width in the direction D2 of a portion on the first end surface 21 side (a portion close to the through hole 21a) is smaller than a width in the direction D2 of a portion on the second end surface 22 side (a portion close to the step 30e). In this case, since the width of the guide groove 31 at the step 30e is large, the optical fiber 10 can be easily accommodated in the guide groove 31, and since the width of the guide groove 31 on the first end surface 21 side is small, positioning of the distal end portion of the optical fiber 10 can be performed with high accuracy.

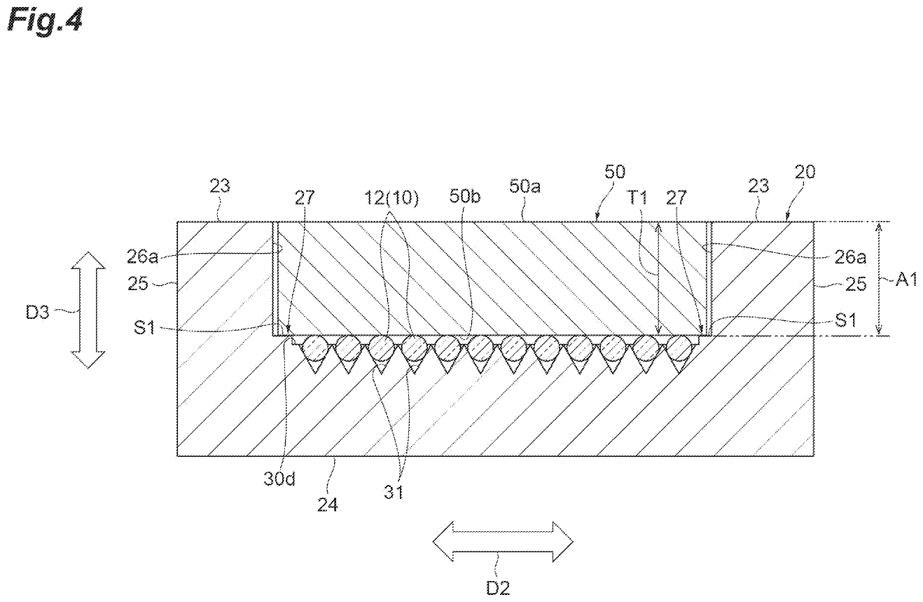

Here, a cross-sectional shape of the guide groove 31 will be described using FIG. 4. FIG. 4 is a view schematically illustrating a cross section of the optical connector 1 illustrated in FIG. 2 taken along line IV-IV. That is, FIG. 4 is a cross-sectional view of the optical connector 1 taken along a plane in the direction D2 and the direction D3 (a plane parallel to the first end surface 21) at a position in which the first portion 26a is provided. As illustrated in FIG. 4, the guide groove 31 is a V-groove with a sharp bottom portion recessed from the fiber support surface 30d toward the lower surface 24. That is, inner walls defining the guide groove 31 are inclined with respect to the fiber support surface 30d and connected at the bottom portion of the guide groove 31. A width of the guide groove 31 in the direction D2 becomes smaller toward the bottom portion. Thereby, the coating-removed portion 12 of the optical fiber 10 accommodated in the guide groove 31 is held to be sandwiched between the inner walls of the guide groove 31. Thereby, a positional deviation of the optical fiber 10 in the direction D2 is prevented. Further, a shape of the guide groove 31 is not limited to the V groove, and may be, for example, a U groove in which a bottom portion thereof has a roundish shape, or a rectangular groove having a bottom surface extending in the direction D1 and the direction D2.

The pressing part 50 is a member that presses the plurality of optical fibers 10 toward the plurality of guide grooves 31. As illustrated in FIG. 1, the pressing part 50 is formed in a plate shape and has an upper surface 50a and a lower surface 50b opposing each other. The upper surface 50a and the lower surface 50b each have a rectangular shape. The upper surface 50a and the lower surface 50b are each formed such that a width W4 of a long side (width in the direction D2) thereof is formed slightly smaller than the opening width W1 of the first portion 26a of the window part 26. Thereby, the pressing part 50 can be fitted inside the first portion 26a of the window part 26. Also, the width W4 of the pressing part 50 is larger than the opening width W2 of the second portion 26b and the opening width W3 of the third portion 26c. As a result, movement of the pressing part 50 fitted into the first portion 26a in the direction D1 is restricted, and a positional deviation of the pressing part 50 is prevented.

The pressing part 50 may be formed of a light transmitting material such as glass that transmits ultraviolet rays. An ultraviolet curable type adhesive may be injected into the accommodating part 30 to fix the plurality of optical fibers 10 to the inner wall of the accommodating part 30. In this case, the adhesive is irradiated with ultraviolet rays from the outside of the ferrule 20. Since the pressing part 50 is formed of a material that transmits ultraviolet rays, the adhesive injected into the accommodating part 30 can be easily irradiated with ultraviolet rays. Also, if the adhesive that fixes the plurality of optical fibers 10 to the inner wall of the accommodating part 30 is a thermosetting type adhesive, the pressing part 50 may be formed of the same material (for example, PPS resin) as the ferrule 20. Thereby, a difference between a heat shrinkage rate of the ferrule 20 and a heat shrinkage rate of the pressing part 50 can be reduced, and damage to the optical connector 1 due to change in temperature can be prevented.

The upper surface 50a and the lower surface 50b are formed flat. For example, surface roughness of the upper surface 50a and the lower surface 50b may be 1 μm or less. Here, the surface roughness refers to an index representing a degree of unevenness on a surface, and is an arithmetic average roughness Ra defined in JIS B 0601. The surface becomes closer to a smooth surface as the arithmetic average roughness Ra is smaller. As illustrated in FIG. 4, the lower surface 50b of the pressing part 50 fitted into the first portion 26a is in contact with side surfaces of the coating-removed portions 12 of the plurality of optical fibers 10. The plurality of optical fibers 10 are pressed toward the plurality of guide grooves 31 by the pressing part 50. That is, the lower surface 50b of the pressing part 50 functions as a pressing surface that presses the plurality of optical fibers 10.

As illustrated in FIG. 4, the pressing part 50 has a thickness T1 (width from the upper surface 50a to the lower surface 50b) in the direction D3. Also, the first portion 26a of the ferrule 20 has a depth A1 along the direction D3 from the upper surface 23 to the placement surface S1. The pressing part 50 is formed such that the thickness T1 thereof is the same as the depth A1 from the upper surface 23 to the placement surface S1 of the ferrule 20. Therefore, the upper surface 50a of the pressing part 50 fitted into the first portion 26a is positioned on the same plane as the upper surface 23 of the ferrule 20. Further, a size of the thickness T1 of the pressing part 50 may be smaller or larger than the depth A1 from the upper surface 23 to the placement surface S1 of the ferrule 20.

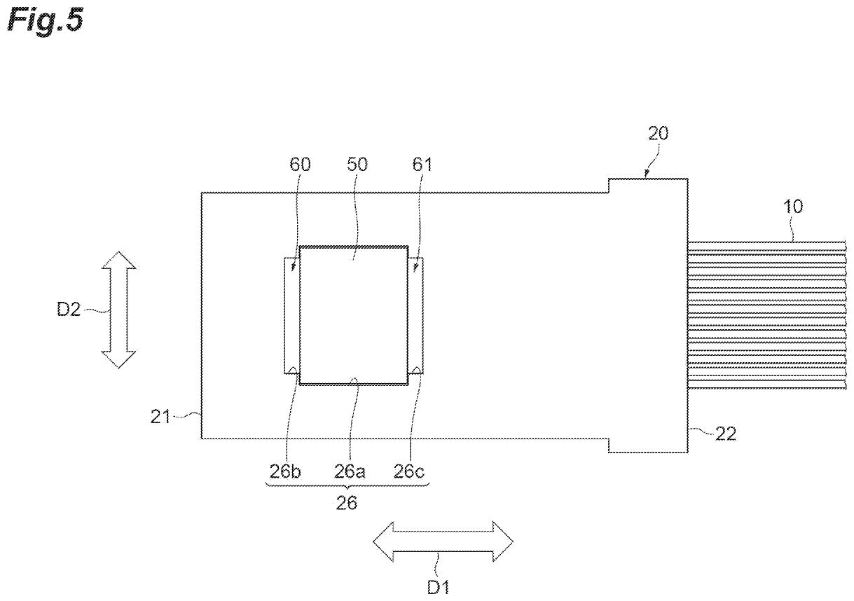

FIG. 5 is a view of the optical connector 1 with the pressing part 50 fitted into the window part 26 seen from the upper surface 23 side. As illustrated in FIG. 5, the pressing part 50 is fitted so that a first gap 60 and a second gap 61 are provided between itself and the inner wall of the window part 26. The first gap 60 is a gap provided between the inner wall of the second portion 26b of the window part 26 and the pressing part 50. The first gap 60 is positioned on the first end surface 21 side with respect to the pressing part 50. The first gap 60 is provided to extend in the direction D2. A width of the first gap 60 in the direction D1 may be, for example, 0.1 mm or more and 1 mm or less in size.

The second gap 61 is a gap provided between the inner wall of the third portion 26c of the window part 26 and the pressing part 50. The second gap 61 is positioned on the second end surface 22 side with respect to the pressing part 50. That is, the first gap 60 and the second gap 61 are positioned to sandwich the pressing part 50 in the direction D1. The second gap 61 is provided to extend in the direction D2. A width of the second gap 61 in the direction D1 may be, for example, 0.1 mm or more and 1 mm or less in size. Also, an opening area of the window part 26 in a state in which the pressing part 50 is not fitted is defined as an area Sa, and a sum of an opening area of the first gap 60 and an opening area of the second gap 61 is defined as an area St. In this case, a proportion occupied by the area St with respect to the area Sa may be, for example, 10% or more and 50% or less, or may be 20% or more and 40% or less.

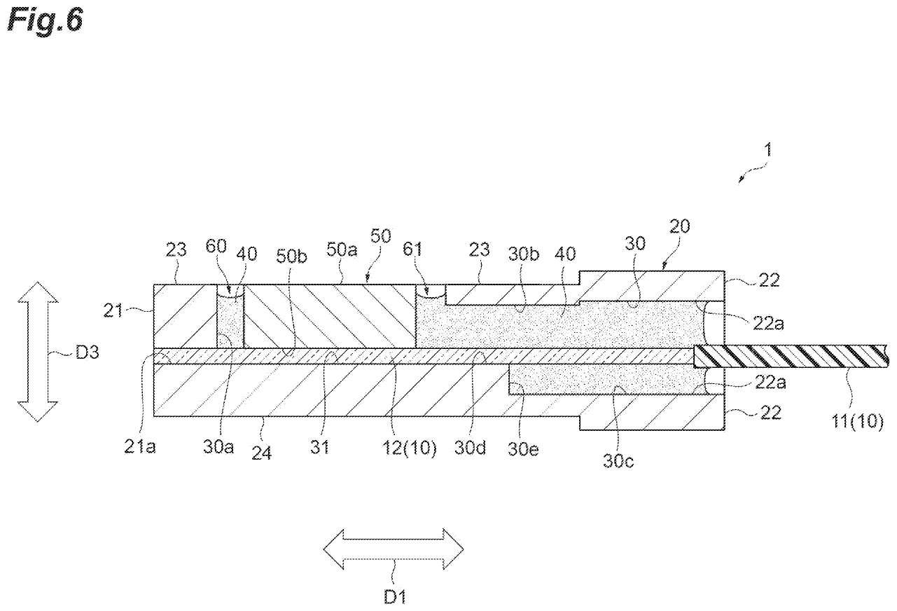

FIG. 6 is a view schematically illustrating a cross section of the optical connector 1 with an adhesive 40 injected into the accommodating part 30. As illustrated in FIG. 6, the optical connector 1 includes the adhesive 40 that fixes the optical fiber 10 to the inner wall of the accommodating part 30. The adhesive 40 is injected into the accommodating part 30 through the window part 26 in a state in which the pressing part 50 is not fitted into the window part 26. After the adhesive 40 is injected, the pressing part 50 is fitted into the window part 26. In the present embodiment, the adhesive 40 is injected until it reaches a position at which it covers a part of the coated portion 11 of the optical fiber 10. Also, the adhesive 40 is injected until it reaches the inside of the window part 26. The adhesive 40 may enter, for example, a gap between the guide groove 31 and the coating-removed portion 12 of the optical fiber 10. The adhesive 40 need only be injected by an amount capable of fixing the optical fiber 10 to the accommodating part 30, and does not necessarily have to fill the entire region of the accommodating part 30. For example, the adhesive 40 may be provided only on the fiber support surface 30d. Apart of a surface of the adhesive 40 is in contact with outside air of the ferrule 20 via the first gap 60 and the second gap 61. Further, the adhesive 40 used here may be, for example, an optical adhesive. When the adhesive 40 is an optical adhesive, it is possible to perform both matching of a refractive index of the adhesive 40 used for the distal end of the optical fiber 10 and fixing the optical fiber 10 to the guide groove 31 or the like.

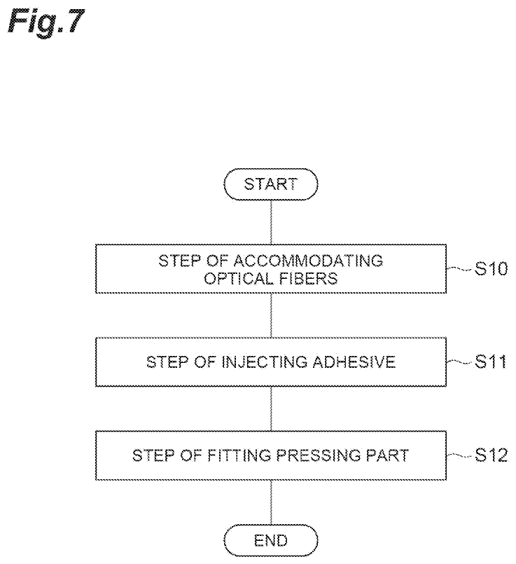

FIG. 7 is a flowchart showing a method for manufacturing the optical connector 1. A method for manufacturing the optical connector 1 described above will be described using FIG. 7. First, end portions of the plurality of optical fibers 10 are accommodated in the accommodating part 30 of the ferrule 20 (step S10). Specifically, distal ends of the plurality of optical fibers 10 are accommodated in the accommodating part 30 through the opening 22a provided at the second end surface 22 of the ferrule 20 illustrated in FIG. 3. Thereafter, the distal ends of the optical fibers 10 are moved to the first end surface 21 side along the plurality of guide grooves 31. At this time, operations of accommodating and moving the optical fibers 10 may be performed while checking positions, shapes, and the like of the guide grooves 31 through the window part 26 of the ferrule 20. Thereafter, the distal ends of the optical fibers 10 are inserted into the plurality of through holes 21a.

Next, the adhesive 40 is injected into the accommodating part 30 (step S11). At this time, the adhesive 40 may be injected into the accommodating part 30 through the window part 26 of the ferrule 20 (see FIG. 6). Also, the injected adhesive 40 may move to the second end surface 22 side to reach a position at which it covers the end portion of the coated portion 11 of the optical fiber 10.

Thereafter, the pressing part 50 is fitted into the window part 26 (step S12). At this time, as illustrated in FIG. 5, the pressing part 50 is fitted into the first portion 26a so that the first gap 60 is provided between the inner wall of the second portion 26b of the window part 26 and the pressing part 50, and the second gap 61 is provided between the inner wall of the third portion 26c and the pressing part 50. As illustrated in FIG. 4, the end portions of the pressing part 50 are placed on the placement surfaces S1 of the steps 27 of the first portion 26a. The lower surface 50b of the pressing part 50 comes into contact with side surfaces of the coating-removed portions 12 to press the plurality of optical fibers 10 toward the plurality of guide grooves 31. As described above, the manufacturing process of the optical connector 1 ends.

As described above, in the ferrule 20, the optical connector 1, and the method for manufacturing the optical connector 1 according to the present embodiment, the pressing part 50 is fitted into the window part 26 provided at a position facing the guide grooves 31, and the plurality of optical fibers 10 are pressed toward the guide grooves 31 by the pressing part 50. Thereby, the optical fibers 10 can be prevented from floating upward from the guide grooves 31. Also, the pressing part 50 can be fitted into the window part 26 so that the gaps (the first gap 60 and the second gap 61) are provided between the inner wall of the window part 26 and the pressing part 50. Thereby, even if bubbles are generated in the adhesive 40 that has been injected into the accommodating part 30 of the ferrule 20, the bubbles can be removed through the gaps by a decompression treatment or the like, and mixing of the bubbles into the adhesive 40 can be curbed. Further, since a coating resin of the optical fiber 10 or the adhesive 40 is prevented from being caught between the pressing part 50 and the inner wall of the window part 26 by the provision of the gaps, damage to the optical fiber 10 or the like can be prevented.

In the above-described embodiment, the pressing part 50 is fitted into the window part 26 so that the first gap 60 positioned on the first end surface 21 side with respect to the pressing part 50 is provided between the inner wall of the window part 26 and the pressing part 50. That is, of the upper surface 23 (outer surface) of the ferrule 20, the first gap 60 is provided on the first end surface 21 side in which the distal end of the optical fiber 10 is accommodated. Thereby, even if bubbles are generated in the adhesive 40 positioned in the vicinity of the distal end of the optical fiber 10, the bubbles can be removed through the first gap 60. Therefore, Fresnel loss and deviation of an optical axis due to, for example, bubbles generated on the optical axis of the optical fiber 10 can be more reliably prevented.

In the above-described embodiment, the pressing part 50 is fitted into the window part 26 so that the second gap 61 positioned on the second end surface 22 side with respect to the pressing part 50 is provided between the inner wall of the window part 26 and the pressing part 50. Thereby, bubbles generated in the adhesive 40 can be more efficiently removed not only through the first gap 60 but also through the second gap 61.

In the above-described embodiment, the pressing part 50 is fitted into the window part 26 so that the first gap 60 and the second gap 61 extend in the direction D2 (second direction). That is, the first gap 60 and the second gap 61 are provided in the direction D2 (second direction) in which the plurality of optical fibers 10 are aligned. Thereby, bubbles generated around each of the optical fibers 10 can be more reliably removed through both the gaps.

In the above-described embodiment, the pressing part 50 is a plate-shaped member having the flat lower surface 50b (pressing surface) that presses the plurality of optical fibers 10 toward the plurality of guide grooves 31. Also, a surface roughness of the lower surface 50b may be 1 μm or less. Thereby, since the plurality of optical fibers 10 are pressed by the flat lower surface 50b, a load being concentrated on a specific optical fiber 10 can be suppressed. Thereby, damage to the optical fibers 10 can be prevented.

In the above-described embodiment, the step 27 having the placement surface S1 on which the end portion of the pressing part 50 can be placed is formed on the inner wall of the window part 26. Thereby, since movement of the pressing part 50 toward the guide grooves 31 is restricted by the placement surface S1 of the step 27, the pressing part 50 is not excessively pushed toward the guide grooves 31. Therefore, damage to the optical fibers 10 positioned between the pressing part 50 and the guide grooves 31 can be prevented.

In the above-described embodiment, the window part 26 includes the first portion 26a whose opening width on the upper surface 23 in the direction D2 is larger than the width W4 of the pressing part 50 in the direction D2, and the second portion 26b and the third portion 26c whose opening widths on the upper surface 50a in the direction D2 are each smaller than the width W4 of the pressing part 50 in the direction D2. Also, the second portion 26b and the third portion 26c are positioned to sandwich the first portion 26a in the direction D1, and the pressing part 50 is fitted into the first portion 26a. Thereby, fitting of the pressing part 50 into an appropriate position of the window part 26 is facilitated. Also, a positional deviation of the pressing part 50 in the direction D1 is prevented.

### First Modified Example

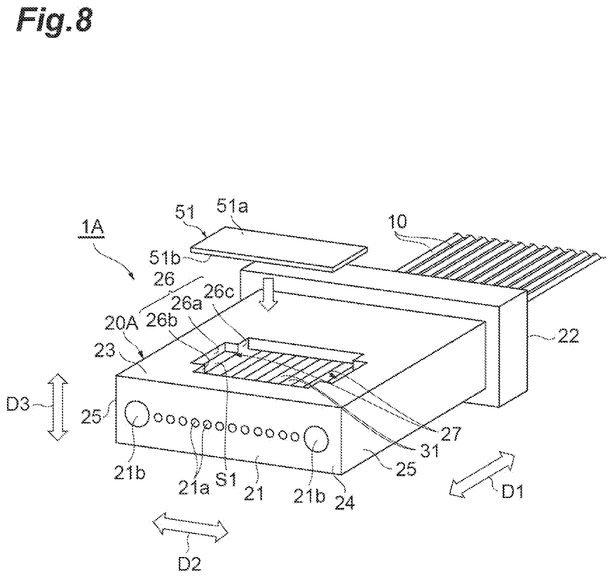

A first modified example of the optical connector 1 will be described using FIG. 8. FIG. 8 is a perspective view illustrating an optical connector 1A according to the first modified example. In the following description, differences from the optical connector 1 according to the above-described embodiment will be mainly described, and description of common points may be omitted.

The optical connector 1A according to the first modified example includes a plurality of optical fibers 10 and a ferrule 20A that holds the plurality of optical fibers 10. The ferrule 20A includes a pressing part 51 fitted in a window part 26. The pressing part 51 according to the first modified example is formed thinner than the pressing part 50 according to the above-described embodiment. Specifically, the pressing part 51 according to the first modified example is formed to have a thickness (width from an upper surface 51a to a lower surface 51b) smaller than the thickness T1 (see FIG. 4) of the pressing part 50 according to the above-described embodiment. That is, the thickness of the pressing part 51 according to the first modified example is smaller than a depth (corresponding to the depth A1 in FIG. 4) from an upper surface 23 of the ferrule 20 to a placement surface S1. Therefore, the upper surface 51a of the pressing part 51 fitted into the window part 26 is present at a position lower than that of the upper surface 23 of the ferrule 20 (lower side in a direction D3). The thickness of the pressing part 51 may be, for example, half or less of the depth A1 from the upper surface 23 of the ferrule 20 to the placement surface S1. According to the optical connector 1A according to the present modified example, the entire structure of the pressing part 51 is accommodated in the window part 26 and does not protrude from an opening of the window part 26 toward the outside of the ferrule 20A. Thereby, miniaturization of the optical connector 1A can be achieved.

### Second Modified Example

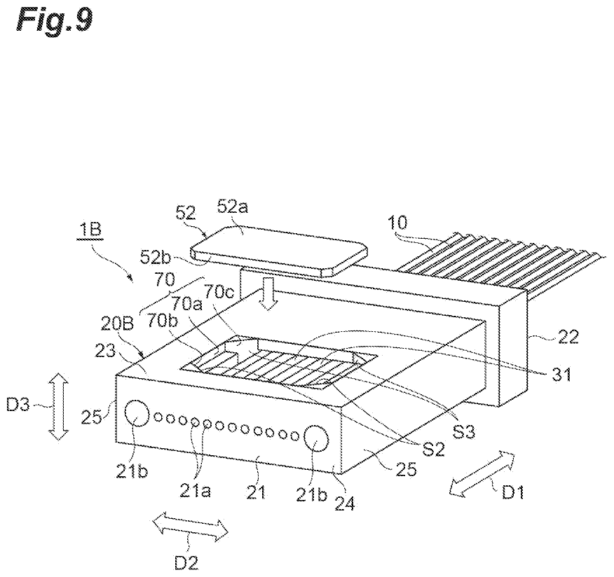

A second modified example of the optical connector 1 will be described using FIG. 9. FIG. 9 is a perspective view illustrating an optical connector 1B according to the second modified example. In the following description, differences from the optical connector 1 according to the above-described embodiment will be mainly described, and description of common points may be omitted.

The optical connector 1B according to the second modified example includes a plurality of optical fibers 10 and a ferrule 20B that holds the plurality of optical fibers 10. The ferrule 20B includes a window part 70 on an upper surface 23 thereof. The window part 70 includes a first portion 70a, a second portion 70b, and a third portion 70c. As in the above-described embodiment, the second portion 70b and the third portion 70c are positioned to sandwich the first portion 70a in a direction D1. The second portion 70b is positioned on a first end surface 21 side with respect to the first portion 70a and the third portion 70c. An inner wall of the second portion 70b has a pair of inclined surfaces S2. The pair of inclined surfaces S2 are provided to be inclined with respect to the direction D1 so that they approach each other toward the first end surface 21 side. Also, an inner wall of the third portion 70c has a pair of inclined surfaces S3. The pair of inclined surfaces S3 are provided to be inclined with respect to the direction D1 so that they approach each other toward the second end surface 22 side. Thereby, an opening of the window part 70 on the upper surface 23 has a rectangular shape (octagonal shape) in which four corners are chamfered.

The ferrule 20B includes a pressing part 52. The pressing part 52 is a plate-shaped member and has an upper surface 52a and a lower surface 52b opposing each other. The upper surface 52a and the lower surface 52b have a rectangular shape (octagonal shape) in which four corners are chamfered. The pressing part 52 is fitted into the window part 70 so that the four chamfered corners are in contact with the pair of inclined surfaces S2 of the second portion 70b and the pair of inclined surfaces S3 of the third portion 70c. According to the optical connector 1B according to the present modified example, since the four corners of the pressing part 52 fitted in the window part 70 are in contact with the inner wall of the window part 70, a positional deviation of the pressing part 52 is prevented.

### Third Modified Example

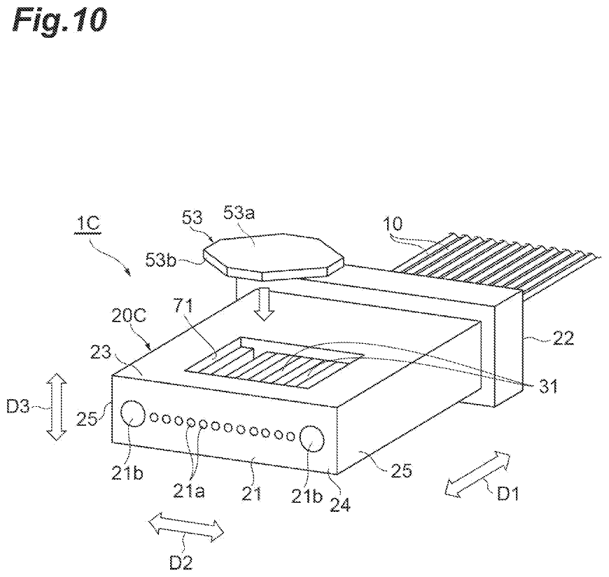

A third modified example of the optical connector 1 will be described using FIG. 10. FIG. 10 is a perspective view illustrating an optical connector 1C according to a third modified example. In the following description, differences from the optical connector 1 according to the above-described embodiment will be mainly described, and description of common points may be omitted.

The optical connector 1C according to the third modified example includes a plurality of optical fibers 10 and a ferrule 20C that holds the plurality of optical fibers 10. The ferrule 20C includes a window part 71 on an upper surface 23 thereof. The window part 71 differs from the window part 26 according to the above-described embodiment in that an opening width on the upper surface 23 in a direction D2 is constant. Also, the ferrule 20C includes a pressing part 53. The pressing part 53 is a plate-shaped member and has an upper surface 53a and a lower surface 53b opposing each other. The upper surface 53a and the lower surface 53b have a rectangular shape (octagonal shape) in which four corners are chamfered. The pressing part 53 is fitted into the window part 71 so that the chamfered four corners are in contact with inner walls of the window part 71 facing each other in a direction D1 and inner walls facing each other in the direction D2. According to the optical connector 1C according to the present modified example, since the four corners of the pressing part 53 fitted in the window part 71 are in contact with the inner walls of the window part 71, a positional deviation of the pressing part 53 is prevented.

### Fourth Modified Example

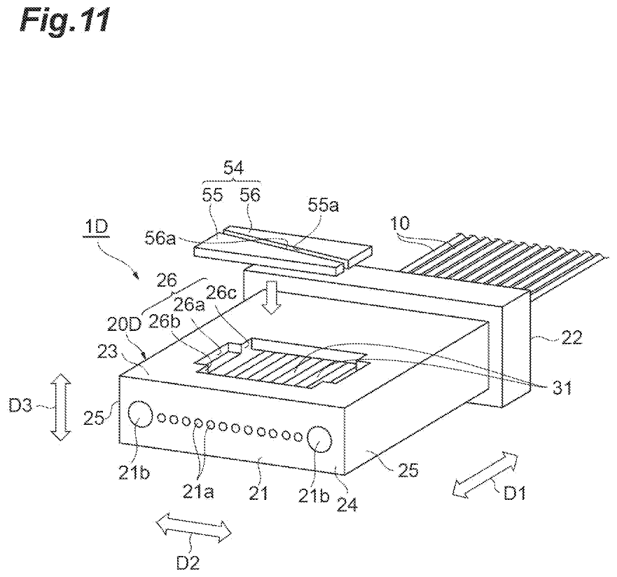

A fourth modified example of the optical connector 1 will be described using FIG. 11. FIG. 11 is a perspective view illustrating an optical connector 1D according to the fourth modified example. In the following description, differences from the optical connector 1 according to the above-described embodiment will be mainly described, and description of common points may be omitted.

The optical connector 1D according to the fourth modified example includes a plurality of optical fibers 10 and a ferrule 20D that holds the plurality of optical fibers 10. The ferrule 20D includes a pressing part 54 fitted in a window part 26. Unlike the pressing part 50 according to the above-described embodiment, the pressing part 54 according to the fourth modified example can be divided into two members. Specifically, the pressing part 54 is divided into a first pressing part 55 and a second pressing part 56. The first pressing part 55 and the second pressing part 56 include a parted surface 55a and a parted surface 56a which extend in a direction intersecting a direction D2 at an acute angle. The pressing part 54 is divided into the first pressing part 55 and the second pressing part 56 by separating the parted surface 55a and the parted surface 56a from each other. In a state in which the pressing part 54 is fitted in a first portion 26a, the parted surface 55a and the parted surface 56a are in contact with each other.

Further, the parted surface 55a and the parted surface 56a may extend in the direction D2 or may extend in a direction D1. Also, the pressing part 54 may be divided into three or more members.

### Fifth Modified Example

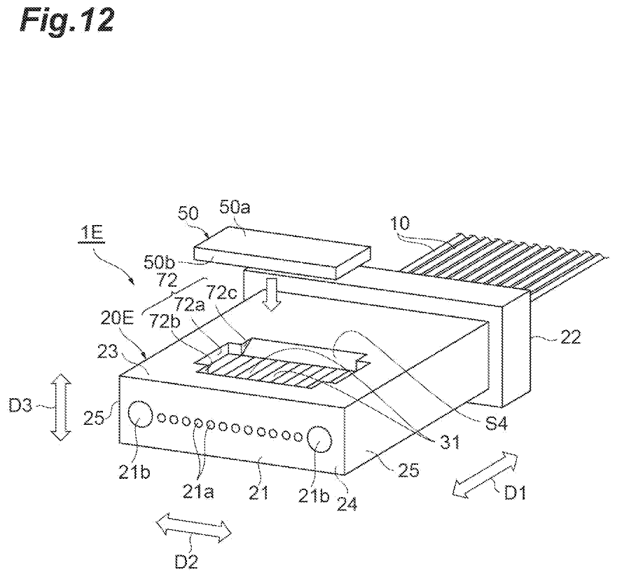

A fifth modified example of the optical connector 1 will be described using FIG. 12. FIG. 12 is a perspective view illustrating an optical connector 1E according to the fifth modified example. In the following description, differences from the optical connector 1 according to the above-described embodiment will be mainly described, and description of common points may be omitted.

The optical connector 1E according to the fifth modified example includes a plurality of optical fibers 10 and a ferrule 20E that holds the plurality of optical fibers 10. The ferrule 20E includes a window part 72 on an upper surface 23 thereof. The window part 72 includes a first portion 72a, a second portion 72b, and a third portion 72c. As in the above-described embodiment, the second portion 72b and the third portion 72c are positioned to sandwich the first portion 72a in a direction D1. The second portion 72b is positioned on a first end surface 21 side with respect to the first portion 72a. The third portion 72c is positioned on a second end surface 22 side with respect to the first portion 72a. The third portion 72c has a sloped surface S4. Of inner walls of the third portion 72c, the sloped surface S4 is provided on the second end surface 22 side. The sloped surface S4 extends to approach the first end surface 21 side from the upper surface 23 toward a lower surface 24 of the ferrule 20. Since the third portion 72c has the sloped surface S4, an opening area of the window part 72 at the upper surface 23 is larger than an opening area at an inner wall (upper inner surface 30b) of an accommodating part 30. Also, similarly to the third portion 72c, the second portion 72b has a sloped surface (not illustrated) on an inner wall on the first end surface 21 side. The sloped surface of the second portion 72b extends to approach the second end surface 22 side from the upper surface 23 toward the lower surface 24 of the ferrule 20.

When an adhesive 40 is injected into the accommodating part 30 of the ferrule 20, if an amount of the adhesive 40 is too much, there is a likelihood that the adhesive 40 will leak from the gap between the inner wall of the window part 72 and the pressing part 50. However, in the optical connector 1E according to the present modified example, gaps are formed between the pressing part 50 and the sloped surfaces of the inner walls of the second portion 72b and the third portion 72c of the window part 72. An opening area of the gap on the upper surface 23 is larger than an opening area on the upper inner surface 30b of the accommodating part 30. In this case, an amount of the adhesive 40 that can be held by the gap increases toward the upper surface 23 side. Thereby, the adhesive 40 can be prevented from leaking from the gap between the inner wall of the window part 72 and the pressing part 50.

Further, in the present modified example, the sloped surface is provided on the inner walls of the second portion 72b and the third portion 72c of the window part 72, but the sloped surface may be provided only on either inner wall of the second portion 72b and the third portion 72c.

### Sixth Modified Example

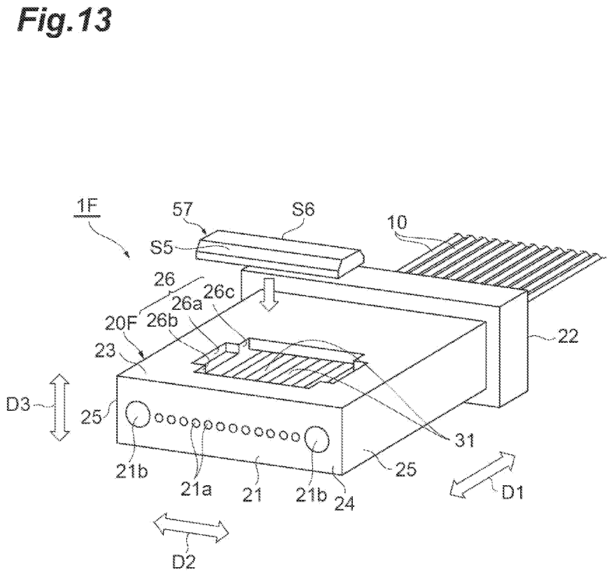

A sixth modified example of the optical connector 1 will be described using FIG. 13. FIG. 13 is a perspective view illustrating an optical connector IF according to the sixth modified example. In the following description, differences from the optical connector 1 according to the above-described embodiment will be mainly described, and description of common points may be omitted.

The optical connector IF according to the sixth modified example includes a plurality of optical fibers 10 and a ferrule 20F that holds the plurality of optical fibers 10. The ferrule 20F includes a pressing part 57 fitted into a window part 26. The pressing part 57 has a sloped surface S5 and a sloped surface S6 on side surfaces thereof. The sloped surface S5 is a surface formed on a first end surface 21 side with respect to the sloped surface S6. The sloped surface S5 extends to approach the first end surface 21 side of the ferrule 20 from an upper side to a lower side in a direction D3. A gap is provided between the sloped surface S5 and an inner wall of a second portion 26b of the window part 26 with the pressing part 57 fitted in the window part 26.

The sloped surface S6 is a side surface formed on a second end surface 22 side with respect to the sloped surface S5. The sloped surface S6 extends to approach the second end surface 22 side of the ferrule 20 from the upper side to the lower side in the direction D3. A gap is provided between the sloped surface S6 and an inner wall of a third portion 26c of the window part 26 with the pressing part 57 fitted in the window part 26.

When an adhesive 40 is injected into an accommodating part 30 of the ferrule 20, if an amount of the adhesive 40 is too much, there is a likelihood that the adhesive 40 will leak from the gap between the inner wall of the window part 26 and the pressing part 57. However, in the optical connector IF according to the present modified example, gaps are formed between the window part 26, and the sloped surface S5 and the sloped surface S6 of the pressing part 57. Then, an opening area of the gap on the upper surface 23 is larger than an opening area on the upper inner surface 30b of the accommodating part 30. In this case, an amount of the adhesive 40 that can be held by the gap increases toward the upper surface 23 side. Thereby, the adhesive 40 can be prevented from leaking from the gap between the inner wall of the window part 26 and the pressing part 57.

While the embodiments of the present invention have been described in detail above, the present invention is not limited to the above-described embodiments and can be applied to various embodiments.

For example, in the present embodiment, two gaps (the first gap 60 and the second gap 61) are provided between the inner wall of the window part 26 and the pressing part 50 as illustrated in FIG. 5, but the number of gaps is not limited. For example, one of the first gap 60 and the second gap 61 may not be provided. Also, in the present embodiment, the first gap 60 and the second gap 61 are provided to extend in the direction D2, but they may be provided to extend in the direction D1. In this case, for example, the window part 26 and the pressing part 50 may be provided in a direction in which they are rotated 90 degrees from the state illustrated in FIG. 5. That is, the first portion 26a, the second portion 26b, and the third portion 26c may be provided to be aligned in the direction D2.

### REFERENCE SIGNS LIST

1, 1A, 1B, 1C, 1D, 1E, IF Optical connector
10 Optical fiber
11 Coated portion
12 Coating-removed portion
20, 20A, 20B, 20C, 20D, 20E, 20F Ferrule
21 First end surface
21a Through hole
21b Guide hole
22 Second end surface
22a Opening
23 Upper surface (Outer surface)
24 Lower surface
25 Side surface
26, 70, 71, 72 Window part
26a, 70a, 72a First portion
26b, 70b, 72b Second portion
26c, 70c, 72c Third portion
27 Step
30 Accommodating part
30a Distal end side inner surface
30b Upper inner surface
30c Lower inner surface
30d Fiber support surface
30e Step
31 Guide groove
40 Adhesive
50, 51, 52, 53, 54, 57 Pressing part
50a, 51a, 52a, 53a Upper surface
50b, 51b, 52b, 53b Lower surface (Pressing surface)
55 First pressing part
55a Parted surface
56 Second pressing part
56a Parted surface
60 First gap
61 Second gap
S1 Placement surface
S2, S3 Inclined surface
S4, S5, S6 Sloped surface

1. A ferrule comprising:
a first end surface and a second end surface provided opposite to each other in a first direction;
an outer surface provided between the first end surface and the second end surface;
an accommodating part opening at the second end surface and configured to be able to accommodate a plurality of optical fibers therein;
a plurality of guide grooves configured to determine a position and a direction of each of the plurality of optical fibers in the accommodating part, the plurality of guide grooves being provided to each extend in the first direction on an inner wall of the accommodating part and be aligned in a second direction intersecting the first direction;
a window part opening at the outer surface and configured to be connected to the accommodating part; and
a pressing part disposed in the window part to press the plurality of optical fibers toward the plurality of guide grooves,
wherein the window part is provided at a position facing at least a portion of the plurality of guide grooves, and the pressing part is able to be fitted into the window part so that a gap is provided between an inner wall of the window part and the pressing part.

2. The ferrule according to claim 1, wherein the pressing part is fitted into the window part so that a first gap positioned on the first end surface side with respect to the pressing part is provided between the inner wall of the window part and the pressing part.

3. The ferrule according to claim 1, wherein the pressing part is fitted into the window part so that a second gap positioned on the second end surface side with respect to the pressing part is provided between the inner wall of the window part and the pressing part.

4. The ferrule according to claim 1, wherein the pressing part is a plate-shaped member having a flat pressing surface which presses the plurality of optical fibers toward the plurality of guide grooves.

5. The ferrule according to claim 4, wherein the pressing surface has a surface roughness of 1 μm or less.

6. The ferrule according to claim 1, wherein a step having a placement surface on which an end portion of the pressing part is able to be placed is formed on the inner wall of the window part.

7. The ferrule according to claim 1,
wherein the window part includes a first portion whose opening width on the outer surface in the second direction is larger than a width of the pressing part in the second direction, and a second portion and a third portion whose opening widths on the outer surface in the second direction are each smaller than the width of the pressing part in the second direction, and
wherein the second portion and the third portion are positioned to sandwich the first portion in the first direction, and the pressing part is fitted into the first portion.

8. The ferrule according to claim 1, wherein a sloped surface is formed in at least one of the inner wall of the window part and a surface of the pressing part which define the gap so that an opening area of the gap on the outer surface side is larger than an opening area of the gap on the accommodating part side.

9. An optical connector comprising:
the ferrule according to claim 1;
a plurality of optical fibers accommodated in the accommodating part of the ferrule along the plurality of guide grooves; and
an adhesive injected into the accommodating part through the window part to fix the plurality of optical fibers to the inner wall of the accommodating part.

10. A method for manufacturing an optical connector including the ferrule according to claim 1, the method comprising:
accommodating a plurality of optical fibers in the accommodating part of the ferrule along the plurality of guide grooves;
injecting an adhesive for fixing the plurality of optical fibers to the inner wall of the accommodating part into the accommodating part through the window part; and
fitting the pressing part into the window part to press the plurality of optical fibers toward the plurality of guide grooves.
